(19) United States
(12) Patent Application Publication
(10) Pub. No.: US 2017/0103124 A1
(43) Pub. Date: Apr. 13, 2017

(54) Remote search engine using camera

(71) Applicant: Abdelrahman Hassan, Fremont, CA (US)

(72) Inventor: Abdelrahman Hassan, Fremont, CA (US)

(73) Assignee: Abdelrahman Hassan, Fremont, CA (US)

(21) Appl. No.: 15/330,553

(22) Filed: Oct. 7, 2016

Related U.S. Application Data
(60) Provisional application No. 62/284,751, filed on Oct. 7, 2015.

(51) Int. Cl. G06F 17/30; G06F 3/16; G06K 9/00; G06T 11/60; G10L 15/08; G10L 15/22

(52) U.S. Cl. CPC G06F 17/30675; G06F 17/30696; G10L 15/08; G10L 15/22; G06K 9/00442; G06T 11/60; G06F 3/167; G10L 2015/088; G10L 2015/223

(57) ABSTRACT

A remote search method is disclosed to search a printed book, video presented on a computer display, or movie displayed on TV screen. The method utilizes a digital camera of a mobile phone, tablet, or optical head-mounted display. The digital camera captures the picture of the book, video or movie and presents the search result on the digital camera display in real time.

### CROSS-REFERENCE TO RELATED APPLICATION

This application claims the benefits of a U.S. Provisional Patent Application No. 62/284,751, filed Oct. 7, 2015, titled “Search Engine Using Camera”.

### BACKGROUND

Traditional search engines function on electronic devices such as a computer, tablet or mobile phone. They usually interact with digital data stored on a server, or stored on a local computer machine. Data in a format other than digital cannot be searched by computer systems. For example, readers of printed books, magazines, or newspapers cannot search the text of such media while reading. Also, viewers of movies or videos on TV screens or computer displays cannot search the visual data presented on the screens or displays they are watching. Moreover, until now visual data of real-life scenes cannot be searched regardless the spread of digital cameras in various electronic devices such as modern smart phones. All such search restrictions impact the way we learn, study, and work which limits the progress of our society.

### SUMMARY

In one embodiment, the present invention discloses a search method that allows a user to locate a keyword in a printed text using a digital camera of an electronic device. The printed text can be located in a book, magazine, newspaper or the like. The electronic device can be a mobile phone, tablet or optical head-mounted display equipped with a digital camera. For example, in case of using a mobile phone camera to search a book page, the user enters the search keyword through the mobile phone keyboard and uses the mobile phone camera to present the image of the book page on the mobile phone screen. At this moment, the search result is highlighted on the image of the book page on the mobile phone display.

The user can also search the entire book by successively flipping the book pages with one hand while holding the mobile phone with the other hand to locate the book pages within the field of view of the mobile phone camera. Once a search keyword is found in a page the mobile phone generates a sound to indicate finding a search result. At this moment the user can view the highlighted search result on the image of the page on the mobile phone display. This method is also used to search the entire pages of a newspaper. In this case, the user holds the mobile phone and moves it on top of each page of the newspaper, like they are scanning the newspaper pages, one after the other. Once a search result is found the mobile phone generates a sound to indicate locating the search result. To view the exact position of the search result, the user looks at the mobile phone display while capturing the picture of the newspaper page that has the search result to see the highlighted search result.

In one embodiment, providing the search keyword to the electronic device can be done in various manners other than typing. For example, the user can provide vocal instructions indicating the start of the search process and the search keyword, such as “Start, California” which means start searching for the keyword “California”. The user can also provide a picture of a text taken by a camera to search for a similar text within a book, magazine or newspaper. In this case, the picture may include one or more words representing one or more search keywords. Using a picture of text facilitates the user's input of different languages that the user may not be familiar with them.

In yet another embodiment, the present invention discloses a search method that allows a user to locate an object in a plurality of pictures using a digital camera of an electronic device by stating the object's description. The plurality of pictures can be successful frames of a video or movie displayed on a computer or TV screen. For example, in case of using an optical head-mounted display and providing a description of an object by vocal instructions, the present invention highlights a spot on the optical head-mounted display, on top of the object, once this object appears in front of the user in a video or movie.

The object's description can take various formats. In one embodiment, the user can describe the type of the object they are looking for it. For example, the user may require the present invention to search for a black vehicle. In this case, the search result may detect a black car, truck, or cart that appears in a video or movie in front of the user. In another embodiment, the user can describe the behavior of the object. For example, the user may require searching for a flying object. In this case, the search result may lead to detecting a bird, airplane, or balloon flying in a video or movie on a screen in front of the user. If the user requires the present invention to search for a movable objects, in this case the search results may detect cars, airplanes, humans, or animals presented in a video or movie in front of the user.

In one embodiment, the present invention discloses a search method that allows a user to detect a visual pattern in real-life scenes using a digital camera of an electronic device. The visual pattern can be represented by a shape, size, contrast, or the like. For example, the user may require the present invention to search for an animal that looks different than a group of animal that are standing near each other. Also, the user may require the present invention to search for a kid in a group of kids that are taller than him/her. The user may require the present invention to search for a tree leave that has a different color than other leaves of the same tree. In this case, the present invention presents the search result highlighted on the electronic device display of the digital camera.

Generally, the present invention allows the user to search text in printed books, magazines or newspapers, or to search objects presented in videos or movies on computer or TV screens, or to search visual patterns in real-life scenes as will be described subsequently.

### BRIEF DESCRIPTION OF DRAWINGS

FIG. 1 illustrates using the present invention with a text book to locate a search keyword in the text book pages.

FIG. 2 illustrates using the present invention with a mobile phone to search a picture of text presented on a computer display.

FIG. 3 illustrates using the present invention a head mounted-display to search for an object presented in a movie on a TV screen.

FIG. 4 illustrates using the present invention to detect a visual pattern of a unique geometrical shape.

FIG. 5 illustrates a block diagram presenting the steps of the method of the present invention to locate a search keyword in a printed material.

FIG. 6 illustrates a block diagram presenting the steps of the method of the present invention to locate an object in a video or movie.

FIG. 7 illustrates a block diagram presenting the steps of the method of the present invention to locate a visual pattern in a picture.

### DETAILED DESCRIPTION

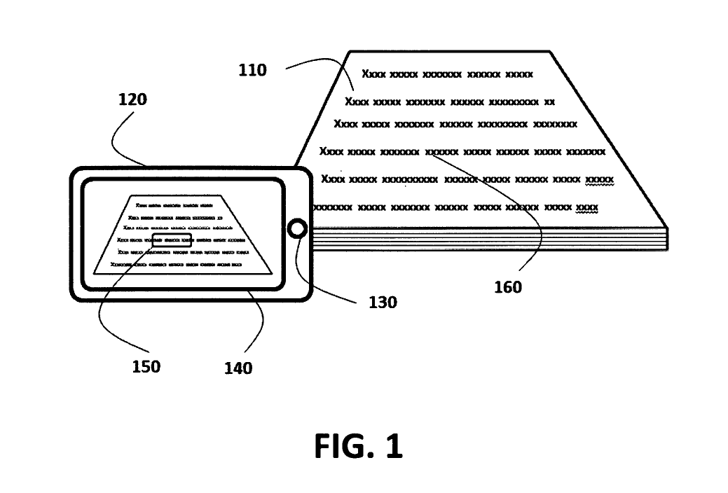

Text books are one of the examples that students cannot search their contents using any available electronic devices such as computers, mobile phones, or tablets. This limitation restricts students to study in an efficient manner. Using the present invention provides a unique solution for this problem. For example, FIG. 1 illustrates a page of a text book 110, and a mobile phone 120 capturing the picture of the page by its digital camera 130 to present the image of the page on the mobile phone display 140. A transparent spot 150 appears on the mobile phone display on top of one of the words 160 of the page. This word is the same search keyword that the user entered to a search program installed on the mobile phone, and the transparent spot is a form of highlighting the search result. When the user moves the mobile phone the position of the page image changes on the mobile phone screen and the transparent spot is automatically relocated to always appear on top of the search result.

The present method allows users to search any page of a book in a simple and fast manner. If the user needs to search the entire book pages there is no need to view the book pages on the mobile phone display until finding the search result. In this case, the user flips the book pages with one hand and holds the mobile phone with the other hand without the need for looking on the mobile phone display. When a search result is found in a page the mobile phone generates a sound to indicate finding the search result. If the user needs to view the position of this search result, they use the mobile phone camera to display the page image with the search result highlighted on the mobile phone screen. Generally, using the present invention for searching the entire pages of a text book allows generating a list of the page numbers that include the search result.

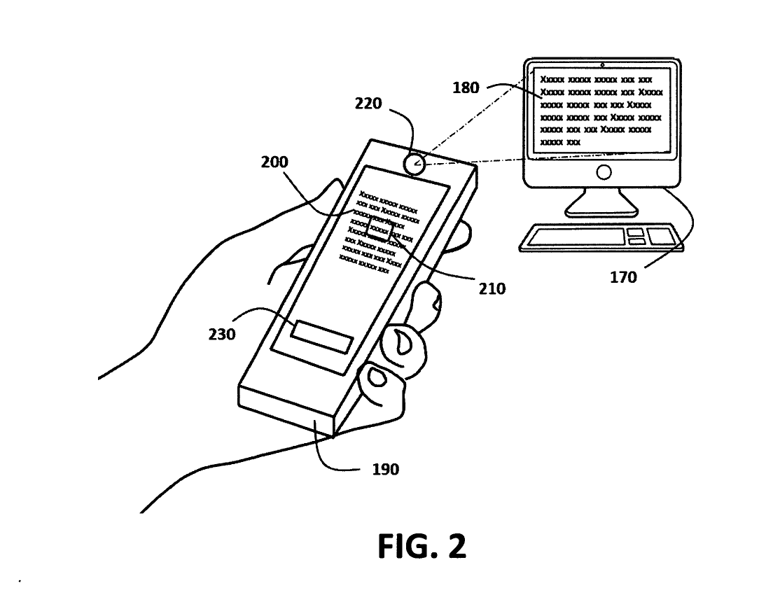

The use of the present invention is not limited to the text books but it can also be used with magazines, newspapers, or any printed media. Moreover, it can be used for searching the pictures that include text and presented on digital displays such as computers or white boards by remotely using the digital camera of the mobile phone or tablet. For example, FIG. 2 illustrates a computer screen 170 presenting a picture of text 180 in a raster format, and a user's hand holding a mobile phone 190 where the image of the text 200 appears on the mobile phone display with a highlighted search result 210. As shown in the figure, the digital camera 220 of the mobile phone captures the image of the text from the computer display. The input box 230 is the box which the user uses to type the search keyword, or to show the search keyword when a vocal instruction is provided instead of typing.

To provide the search keyword through typing the virtual keyboard of the mobile phone is utilized. To provide the search keyword through vocal instructions the user utilizes the mobile phone microphone. For example, when the user says “Start, Pyramid” that means the search program starts searching for the keyword “Pyramid” within the printed material presented in front of the mobile phone camera. If the user says “Start, Pyramid, Geometry” that means the search program is required to search for the keyword “pyramid” as defined in geometry. This is different from saying “Start, Pyramid, History” which leads to searching for the keyword “Pyramid” as defined in history.

Generally, the user can utilize the various search features that are available with modern search engines such as GOOGLE Search. This includes search syntax or queries of simple text, and breaks up the user's text into a sequence of search terms, which will usually be words that are to occur in the results. The user can also use Boolean operators, such as: quotations marks (“) for phrase, a prefix such as “+”, “−” for qualified terms. Also, the present invention utilizes the Query expansion search to the submitted search query, transforming it into the query that will actually be used to retrieve search results. As known in the art, the query expansion (QE) is the process of reformulating a seed query to improve retrieval performance in information retrieval operations. This includes finding synonyms of words and searching for synonyms as well. It also includes finding all the various morphological forms of word by stemming each word in the search query. Additionally, it includes fixing spelling errors and automatically searching for the corrected form or suggesting it in the search results.

Another application of the present invention it to locate an object in a plurality of pictures presented in video or movie frames on a computer or TV screen. In this case, when the present invention is utilized with one of the optical head-mounted displays, the user can see the highlighted search result on the optical head-mounted display indicating the object which the user is searching for it in the video or movie.

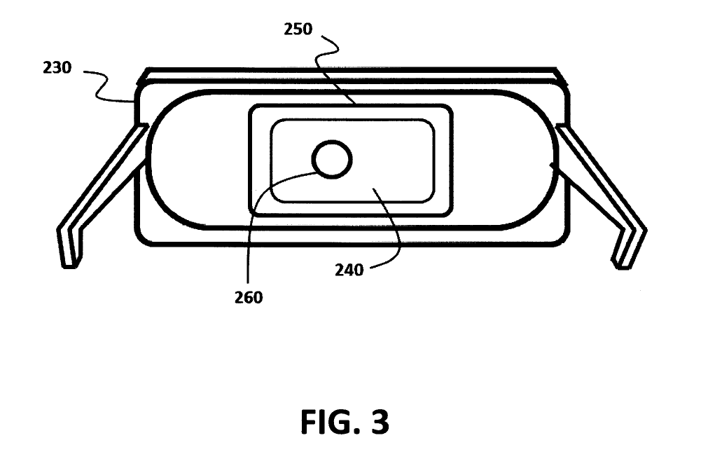

For example, FIG. 3 illustrates an optical head-mounted display 230 viewing a video 240 presented on a computer screen 250. As shown in the figure, a transparent spot 260 appears on the display on top of a certain object indicating the search result. In this case, the user enters the search keyword to the search program by vocal instruction as was described previously. The search keyword usually describes the object which the user is searching for it. In one embodiment, the object's description defines the shape of the object. For example, the user may require the present invention to search for a black vehicle. In this case, the search result may detect a black car, truck, or cart that appears in a video or movie presented in front of the user. In another embodiment, the object's description defines the behavior of the object. For example, the user may require searching for a flying object. In this case, the search result may detect birds, airplanes, and balloons that are flying in a video or movie presented in front of the user. If the user requires searching for movable objects, in this case the search results may detect cars, airplanes, humans, or animals moving in the video or movie displayed in front of the user.

The use of the present invention in searching visual data presented in videos or movies can be extend to search real-life scenes especially when walking down streets and seeing numerous objects at the same moment. Nowadays with the use of modern optical head-mounted displays the user becomes able to search what they are seeing in real time. This includes, people, animals, machines, buildings, street advertisements, and any type of objects that can be seen outdoors while walking or driving a car.

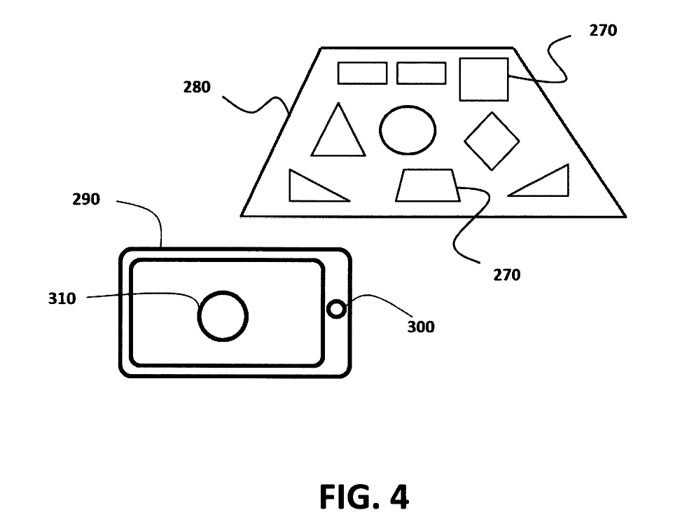

The present invention allows the user to search for visual patterns that appear in printed materials, or appear in videos or movies, or real-life scenes. The search keyword of the visual pattern can be described by a shape, size, contrast, or the like. For example, the user may require the present invention to search for an animal that looks different than a group of animals that are standing near each other. Also, the user may require the present invention to search for a kid within a group of kids that are taller than him/her. The user may require the present invention to search for a tree leave that has a different color or shape than other leaves of the same tree. For example, FIG. 4 illustrates using the present invention to locate a geometrical shape that looks different than other geometrical shapes. As shown in the figure, a plurality of shapes 270 drawn on a piece of paper 280, and a mobile phone 290 with a digital camera 300 capturing the picture of the geometrical shapes to present the search result 310 which is a circle that is has a different pattern than other geometrical shapes.

Such capability of the present invention allows the user not only to recognize the visual data but also to analyze the visual data, in real time, in a scientific manner. This can be used for smart decision making in various industrial, engineering, and medical applications, especially with the advance of the recent research and applications of Artificial Intelligence and computer vision techniques.

Generally, in one embodiment the present invention discloses a method for searching printed text wherein the method comprising; receiving a search keyword; receiving a picture of the printed text according a point of view of a digital camera; converting the text into digital text; searching the digital text to locate the position of the search keyword within the printed text on the display of the digital camera; and presenting a highlighting spot over the position on the display according to the current point of view of the digital camera relative to the printed text.

To achieve this, the digital camera captures the picture of the printed text and provide it to an optical character recognition program “OCR” that converts the image of the printed text into digital text. A search program is utilized to receive the search keyword of the user and search the digital text to locate similar text of the search keyword. Once a search result is found its position on the printed text is defined and highlighted on the display of the digital camera. If the user changes the position of the digital camera the highlighting location changes to correspond to the change of the search result of the printed text on the digital camera display. This is done by using a computer vision program to track the change of the search result on the digital camera display. The digital camera can be a camera of any modern electronic device such as a mobile phone, tablet, computer, optical head-mounted display or the like.

In another embodiment the present invention discloses a method for searching a plurality of pictures that are successively presented in a video or movie, wherein the method comprising; receiving a search keyword; receiving a plurality of pictures according to a point of view of a digital camera; analyzing the content of the plurality of picture using a computer vision program; searching the content to determine a position of a picture of the plurality of pictures that includes a content matching the search keyboard; and presenting a highlighting spot over the position on the display according to the current point of view of the digital camera relative to the picture.

To achieve this, the present invention utilizes a computer vision program to convert each picture of the plurality of pictures into digital text describing the content of the picture. Each description of content is assigned to a position in the picture corresponding to a certain object of plurality of pictures. Once a search result is found the highlighting is placed on the position of the picture image that corresponds to the search result. Another computer vision program or tracking program is utilized to track the change of the position of the picture on the digital camera display when the user changes the position or orientation of the digital camera relative to the plurality of pictures. As described previously, the plurality of pictures can be presented in a video or movie displayed on a digital screen of a computer, TV, or street advertisement.

In yet another embodiment the present invention discloses a method for searching a visual pattern in a scene wherein the method comprising: receiving a search keyword describing the visual pattern; receiving a picture of the scene from a point of view of a digital camera; converting the picture into searchable descriptive data; searching the searchable descriptive data to locate the position of visual pattern in the scene, and presenting a highlighting spot over the position on a display according to the current point of view of the digital camera relative to the scene.

This is achieved by utilizing a computer vision program to analyze the content of the scene, then an analysis program is used to analyze the content and sort it in a searchable manner according to the search keyword that describes the visual pattern. For example, when the search keyword describes a shape of a visual pattern, the analysis program analyzes the content of the scene and lists the shape of each object that appears in the scene assigned with a location corresponding to each object's location. If the search keyword describes the behavior of a visual pattern, the analysis program analyzes the behaviors of each object appears in the scene and assign each behavior with a position in the scene corresponding to the object's location. The same steps are used when the search keyword describes a contrast between an object and other object located in the same scene. This contrast, as described previously, includes contrasts in colors, sizes, shapes, movement, or the like.

Overall, the main advantage of the present invention is utilizing simple technologies in a unique manner to solve a real problem that affects the way we learn and study. This solution can advance various educational and training fields and applications.

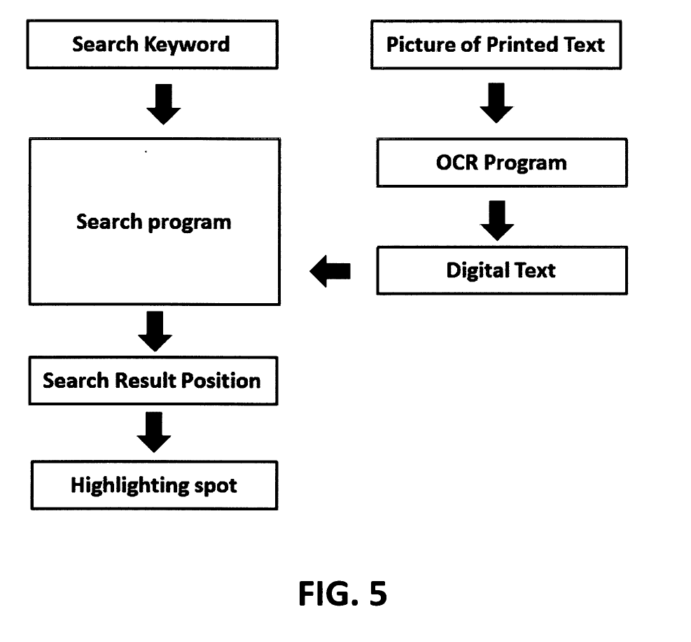

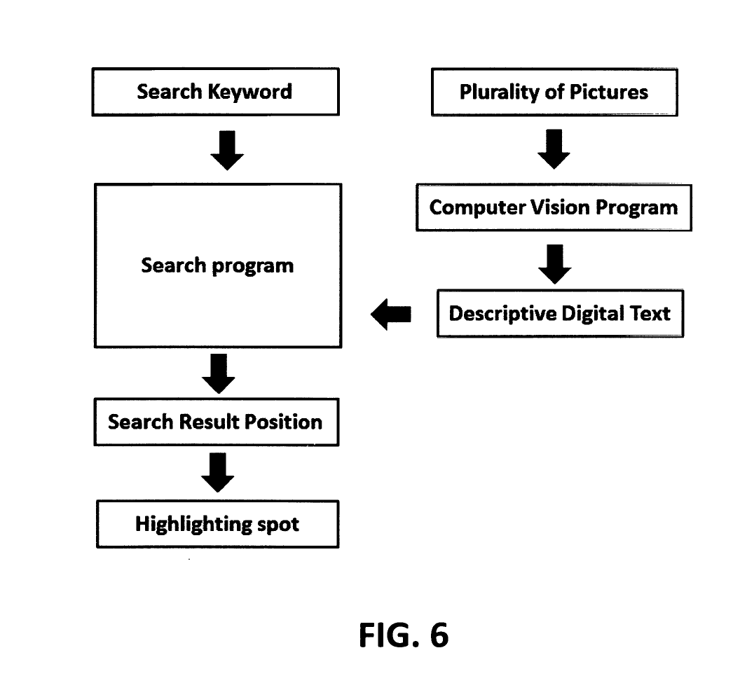

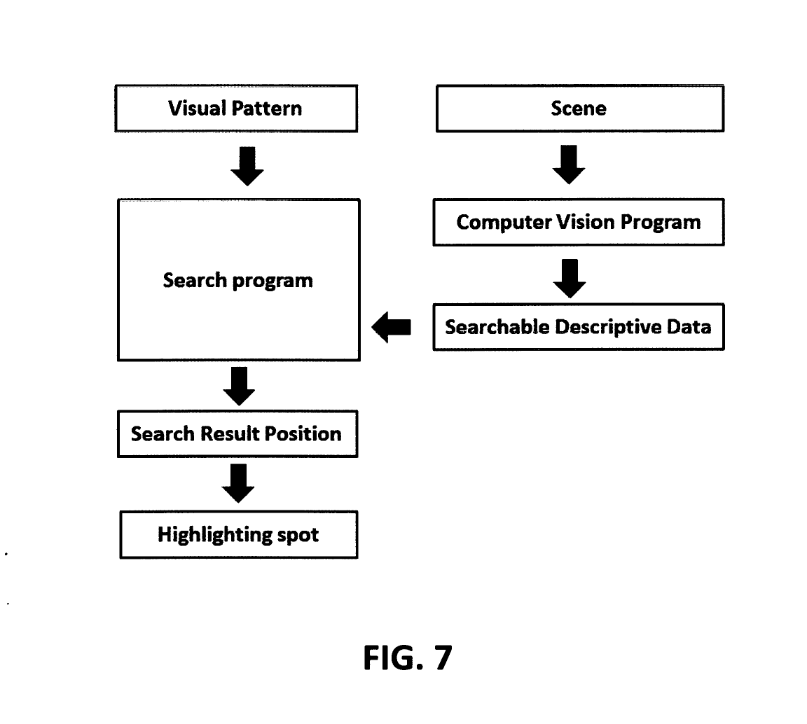

Finally, FIG. 5 illustrates a block diagram presenting the steps of the method of the present invention to locate a search keyword in a printed material. As shown in the figure, the picture of the printed text is provided to an OCR program to convert it into a digital text. A search program receives the search keyword to search the digital text and detect the search result position in the text to show the highlighting spot over the search result. FIG. 6 illustrates a block diagram presenting the steps of the method of the present invention to locate an object in a video or movie. As shown in the figure, a plurality of pictures is provided to a computer vision program to convert it into a descriptive digital text that describes the content of the plurality of pictures. A search program receives the search keyword and searches the descriptive digital text to detect the search result position and present the highlighting spot over the search result. Also, FIG. 7 illustrates a block diagram presenting the steps of the method of the present invention to locate a visual pattern in a scene. As shown in the figure, a scene is received by a computer vision program to convert it into a searchable descriptive data. A search program receives the description of the visual pattern to search the searchable descriptive data and define the search result position to show the highlighting spot over the search result.

1. A method of searching printed text wherein the method comprising;
receiving a search keyword;
receiving a picture of the printed text from a point of view of a digital camera;
converting the text into digital text;
searching the digital text to locate the position of the search keyword within the printed text on the display of the digital camera; and
highlighting the position on the display according to the current point of view of the digital camera relative to the printed text.

2. The method of claim 1 wherein an optical character recognition program is utilized to convert the image of the printed text into digital text.

3. The method of claim 1 wherein a search program is utilized to receive the search keyword and search the digital text.

4. The method of claim 1 wherein a tracking program is utilized to track the change of the position of the printed text on the display and relocate the highlighting accordingly.

5. The method of claim 1 wherein the digital camera is a camera of a mobile phone, tablet or optical head-mounted display.

6. The method of claim 1 wherein the search keyword is provided by typing or vocal instructions.

7. The method of claim 1 wherein the printed text is located in a printed material such as a book, magazine, or newspaper.

8. The method of claim 1 wherein the search keyword is in the form of a search syntax described in a simple text or breaks up into a sequence of search terms.

9. The method of claim 1 wherein the search keyword is in the form of Boolean operators such as quotation marks for phrase or a prefix for qualified terms.

10. The method of claim 1 wherein the search keyword is in the form of Query expansion search that submits the search query to be transformed into a query that retrieves the search results.

11. A method of searching a plurality of pictures that are successfully presented in front of a user wherein the method comprising;
receiving a search keyword;
receiving a plurality of pictures from a point of view of a digital camera;
analyzing the content of the plurality of picture using a computer vision program;
searching the content to determine a position of an object related to the search keyword in the plurality of pictures; and
highlighting the position on the display according to the current point of view of the digital camera relative to the plurality of pictures.

12. The method of claim 11 wherein the computer vision program converts each picture of the plurality of pictures into digital text describing the content of the picture.

13. The method of claim 11 wherein each description of content is assigned to a position in a picture of the plurality of pictures.

14. The method of claim 11 wherein a tracking program is utilized to track the change of the digital camera position to change the position of the highlighting accordingly.

15. The method of claim 11 wherein the plurality of pictures is frames of a video or movie presented on a display.

16. The method of claim 11 wherein the digital camera is a camera of a mobile phone, tablet or optical head mounted display.

17. A method for searching a visual pattern in a scene wherein the method comprising;
receiving a search keyword describing the visual pattern;
receiving a picture of the scene from a point of view of a digital camera;
converting the picture into searchable descriptive data;
searching for the searchable descriptive data to locate the position of visual pattern in the picture; and
highlighting the search result on a display according to the current point of view of the digital camera relative to the scene.

18. The method of claim 17 wherein a computer vision program is utilized to analyze the content of the scene.

19. The method of claim 17 wherein an analysis program is utilized to analyze and sort the content in a searchable manner according to the search keyword that describes the visual pattern.

20. The method of claim 17 wherein the search keyword describes the shape, behavior, or contrast of the visual pattern relative to the scene content.
